(19) United States
(12) Patent Application Publication
(10) Pub. No.: US 2024/0221053 A1
(43) Pub. Date: Jul. 4, 2024

(54) MACHINE LEARNING FOR IMAGE-BASED DETERMINATION OF USER PREFERENCES

(71) Applicant: Capital One Services, LLC, McLean, VA (US)

(72) Inventors: Chih-Hsiang CHOW, Coppell, TX (US); John PHINIZY, Midlothian, VA (US)

(21) Appl. No.: 18/092,614

(22) Filed: Jan. 3, 2023

(51) Int. Cl. G06Q 30/0601; G06F 3/04883

(52) U.S. Cl. CPC G06Q 30/0631; G06F 3/04883; G06Q 30/0643

(57) ABSTRACT

In some implementations, a system may receive user preference selection data indicating one or more selected sections of an image of a vehicle, wherein the one or more selected sections may correspond to one or more vehicle features of the vehicle. The system may receive user feedback associated with the one or more vehicle features. The system may determine, based on the user feedback, one or more user preference scores corresponding to one or more user preference levels associated with the one or more vehicle features. The system may transmit, to a user device, a list of one or more vehicles based on the one or more user preference levels.

### BACKGROUND

Machine learning involves computers learning from data to perform tasks. Machine learning algorithms are used to train machine learning models based on sample data, known as “training data.” Once trained, machine learning models may be used to make predictions, decisions, or classifications relating to new observations. Machine learning algorithms may be used to train machine learning models for a wide variety of applications, including computer vision, natural language processing, financial applications, medical diagnosis, and/or information retrieval, among many other examples.

### SUMMARY

Some implementations described herein relate to a system for image-based determination of user preferences. The system may include a memory and one or more processors communicatively coupled to the memory. The one or more processors may be configured to transmit, to a user device of a user, image data indicating one or more images associated with a vehicle. The one or more processors may be configured to receive, from the user device and for a particular image of the one or more images, user preference selection data indicating a selection by the user of one or more selected sections of the particular image corresponding to one or more vehicle features of the vehicle. The user preference selection data may indicate user feedback associated with the one or more vehicle features. The one or more processors may be configured to identify, using a first machine learning model, the one or more vehicle features corresponding to the one or more selected sections. The first machine learning model may be trained via a plurality of reference images associated with a plurality of reference vehicles. The one or more processors may be configured to provide the user feedback as input to a second machine learning model. The second machine learning model may use a natural language processing technique to process the user feedback. The one or more processors may be configured to receive, as output from the second machine learning model, a user preference score corresponding to a user preference level associated with the one or more vehicle features. The one or more processors may be configured to store, under a user account associated with the user, user preference data indicating the user preference score and the one or more vehicle features.

Some implementations described herein relate to a method of image-based determination of user preferences. The method may include receiving, by a system having one or more processors, user preference selection data indicating one or more selected sections of an image of a vehicle, wherein the one or more selected sections correspond to one or more vehicle features of the vehicle. The method may include receiving, by the system, user feedback associated with the one or more vehicle features. The method may include determining, by the system and based on the user feedback, one or more user preference scores corresponding to one or more user preference levels associated with the one or more vehicle features. The method may include transmitting, by the system and to a user device, a list of one or more vehicles based on the one or more user preference levels.

Some implementations described herein relate to a non-transitory computer-readable medium that stores a set of instructions for a device. The set of instructions, when executed by one or more processors of the device, may cause the device to transmit, to a user device, image data indicating one or more images associated with a vehicle. The set of instructions, when executed by one or more processors of the device, may cause the device to receive, from the user device and for a particular image of the one or more images, user preference selection data indicating a selection of selected sections of the particular image corresponding to a set of vehicle features of the vehicle. The user preference selection data may indicate user feedback associated with the set of vehicle features. The set of instructions, when executed by one or more processors of the device, may cause the device to determine, based on the user feedback, a user preference score corresponding to a user preference level associated with the set of vehicle features. The set of instructions, when executed by one or more processors of the device, may cause the device to store, under a user account associated with the user, user preference data indicating the user preference score and the one or more vehicle features.

Some implementations described herein relate to a method of image-based determination of user preferences. The method may include receiving, by a system having one or more processors, user preference selection data indicating one or more selected sections of an image of a vehicle, wherein the one or more selected sections correspond to one or more vehicle features of the vehicle. The method may include receiving, by the system, user feedback associated with the one or more vehicle features. The method may include determining, by the system and based on the user feedback, a user preference score corresponding to a user preference level associated with the one or more vehicle features. The method may include transmitting, by the system and to a user device, a list of one or more vehicles based on the user preference level.

### BRIEF DESCRIPTION OF THE DRAWINGS

FIGS. 1A-1D are diagrams of an example associated with image-based determination of user preferences, in accordance with some embodiments of the present disclosure.

FIG. 2 is a diagram illustrating an example of training and using a machine learning model in connection with image-based determination of user preferences, in accordance with some embodiments of the present disclosure.

FIG. 3 is a diagram of an example environment in which systems and/or methods described herein may be implemented, in accordance with some embodiments of the present disclosure.

FIG. 4 is a diagram of example components of a device associated with image-based determination of user preferences, in accordance with some embodiments of the present disclosure.

FIG. 5 is a flowchart of an example process associated with image-based determination of user preferences, in accordance with some embodiments of the present disclosure.

### DETAILED DESCRIPTION

The following detailed description of example implementations refers to the accompanying drawings. The same reference numbers in different drawings may identify the same or similar elements.

A search engine may allow users to search for images of products and/or product descriptions corresponding to the images. In some cases, the search engine may allow users to input search parameters to search for images of products and/or product description data that matches the search parameters. As a specific example, a user may search for vehicles based on high-level vehicle characteristics, such as a year, make, and/or model of a vehicle, a color of a vehicle, or a price or price range of a vehicle.

However, searching based on high-level product characteristics may not provide the user with optimal search results that are most relevant to the user. For example, the user may want to view images of products with characteristics that are difficult to describe using a textual search query (e.g., a taillight shape, a hubcap design, and/or a window tinting of a vehicle). As another example, the user may not know or be able to identify or describe the characteristics that are important to the user. In many of these cases, the search engine will be unable to provide search results that satisfy needs of the user because the search results will be identified based on incorrect or absent search parameters. This wastes resources (e.g., processing resources, network resources, and/or memory resources) by identifying and providing a user device with sub-optimal search results that will not be of interest to the user and that are unlikely to assist the user in making a product purchasing decision. This may also lead to excessive web browsing and web navigation (which wastes processing resources, network resources, and/or memory resources) as the user attempts to identify relevant products that were not identified in the search results or were not highly ranked in the search results.

Some implementations described herein relate to a system for determining a user's preferences based on which the system may be able to provide optimal search results. The system may determine the user's preferences based on the user's interaction with one or more images associated with an object (e.g., a vehicle, a house) and feedback provided by the user in association with the user's interaction. For example, the user's interaction may be a selection, from the image(s), of particular features associated with the object, from an image of the object. The user may then provide user feedback associated with the selected feature(s). Based on the user's feedback, the system may determine a level of the user's preference with respect to the selected feature(s), for example, by determining a user preference score associated with those feature(s). The system may then search for and provide search results associated with the object and that are based on the user's preferences.

In this way, the system may provide the user with more relevant search results (e.g., based on the user's preferences) as compared to a search engine that performs a textual search without accounting for inferences about the relative importance of the object features based on the user feedback. As a result, some implementations described herein conserve resources (e.g., processing resources, network resources, and/or memory resources) that would otherwise have been used to search for, obtain, transmit, and display sub-optimal search results that would not be of interest to the user. Furthermore, some implementations described herein conserve resources (e.g., processing resources, network resources, and/or memory resources) that would otherwise be used when sub-optimal results cause the user to continue searching for images of objects that are not returned in the sub-optimal search results.

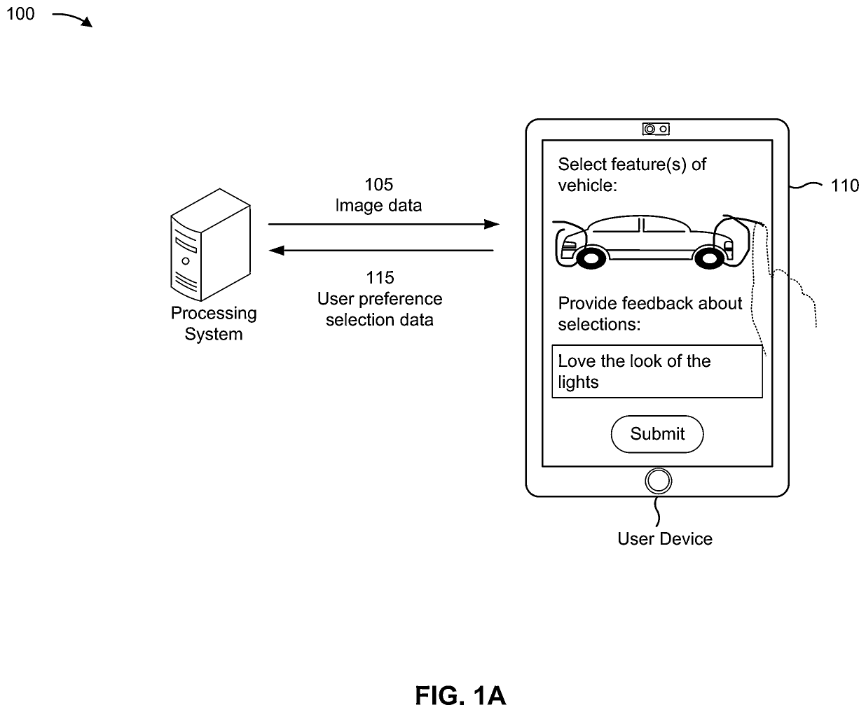

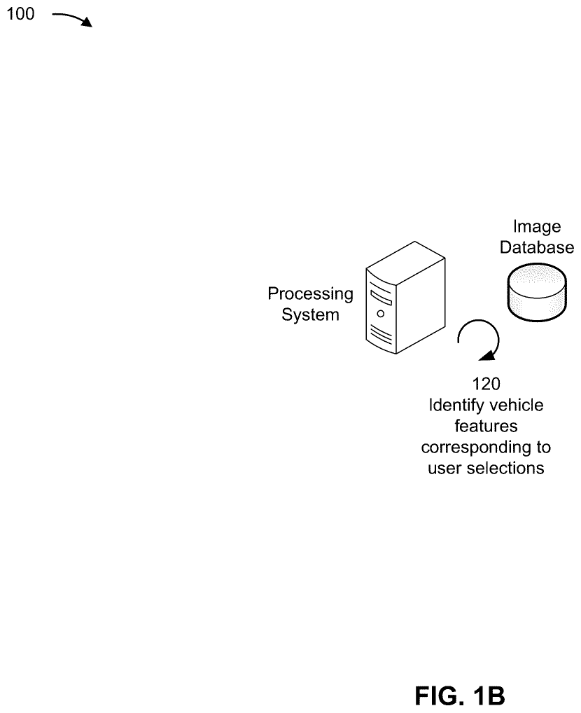

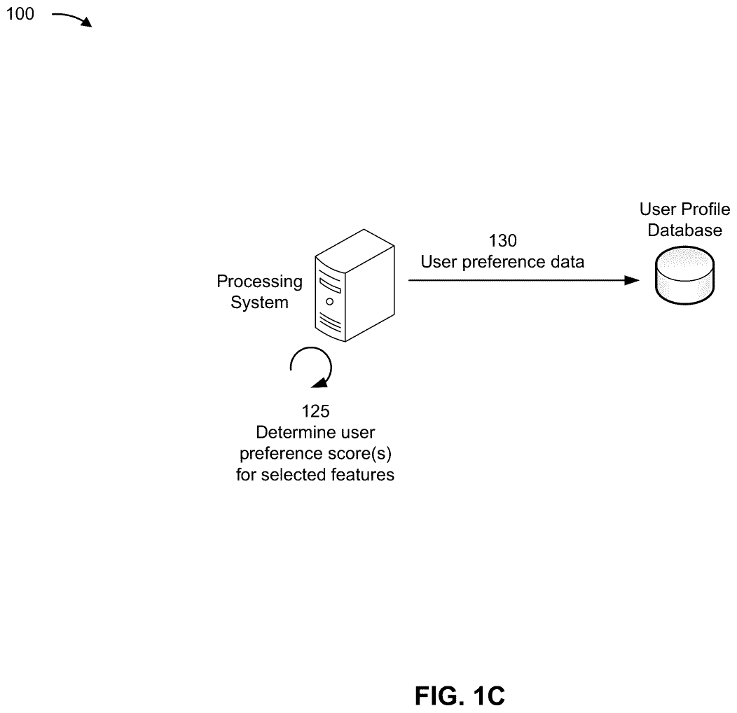

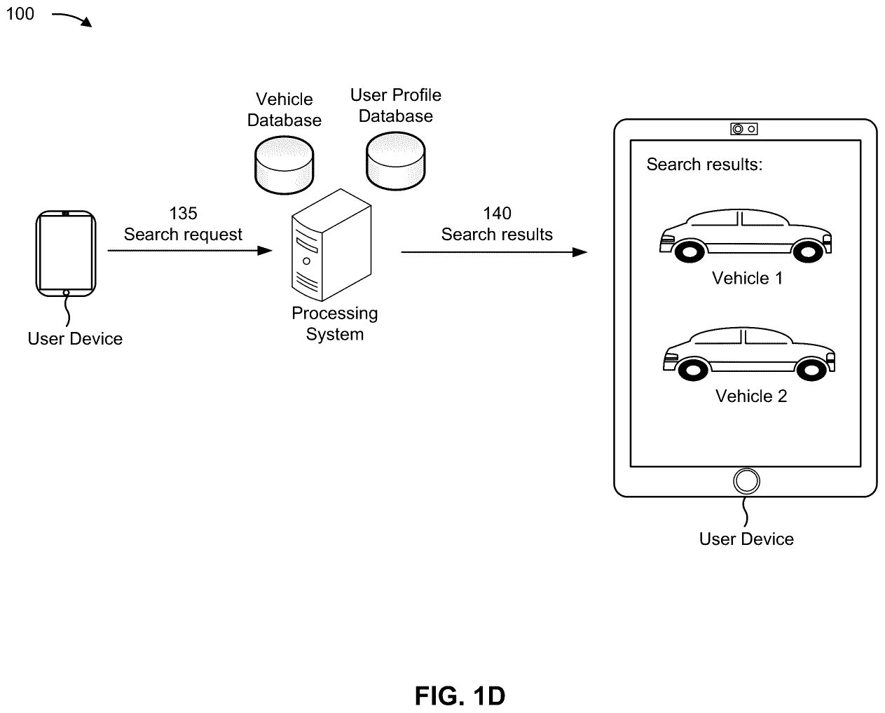

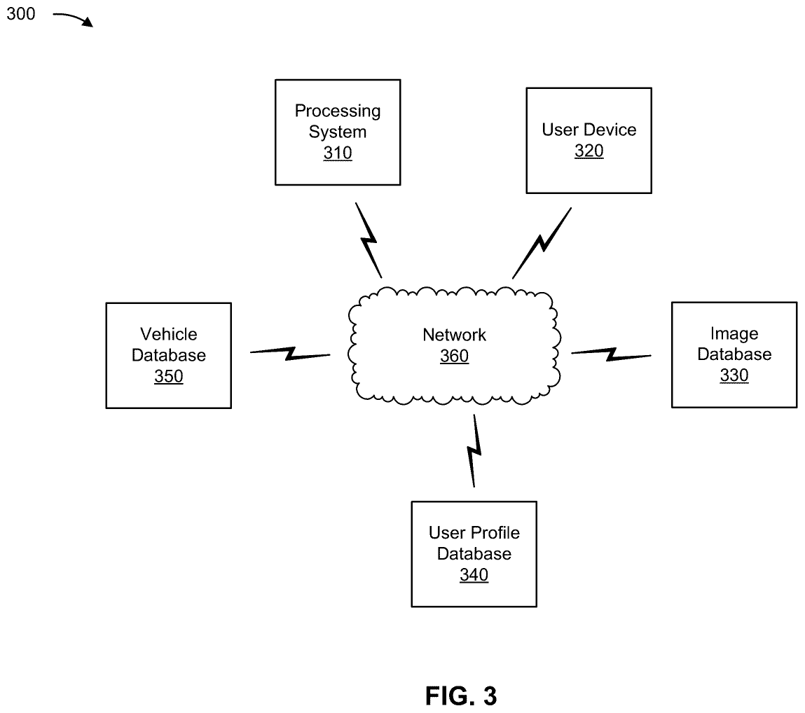

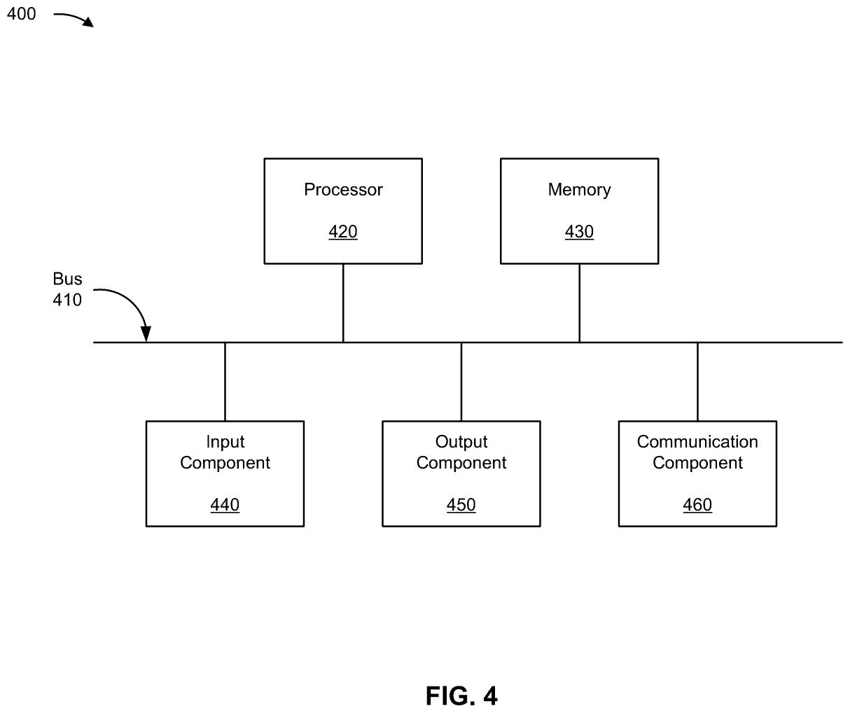

FIGS. 1A-1D are diagrams of an example 100 associated with image-based determination of user preferences. As shown in FIGS. 1A-1D, example 100 includes a processing system, a user device, an image database, a user profile database, and a vehicle database. These devices are described in more detail in connection with FIGS. 3 and 4.

As shown in FIG. 1A, a user, via a user device, may perform an initial request (e.g., a search request) for an object with which the user may be interested in interacting (e.g., renting, leasing, or purchasing). The object may be any object that has multiple features and combinations of features from which the user may choose and from which a search for the object may be filtered. For example, the object may be a vehicle and the features may be related to the interior and/or the exterior of the vehicle. As an example, a feature may be associated with light (e.g., headlight, fog light, brake light, and/or taillight) shape, size, location, and/or configuration. Another exemplary object may be a house. As shown by reference number 105, in response to the request, the processing system may transmit, and the user device may receive, image data indicating an image of or associated with the object (e.g., an exterior image of a vehicle).

As shown by reference number 110, the user device may display the image in a user interface on a display of the user device. The user interface may allow the user to interact with the image. For example, as shown by reference number 110, the user may be able to select certain sections of the image that correspond to one or more features of the object (also referred to as the selected features), and the user device may detect those selections. A feature of the object may be associated with a visual characteristic, such as a shape, a texture, a color, a color pattern, a curvature, a physical size, a luminosity, and/or a design. In some implementations, the user may select the sections by circling the sections (e.g., via a touch interaction or using a cursor). Additionally, or alternatively, the image data may include preset portions that the user may select (e.g., press via a touch interaction or using a cursor). As further shown by reference number 110, the user may provide user feedback associated with the selected feature(s). The user feedback may provide insight into the user's level of preference with respect to the selected feature(s). In some implementations, the user may input, via the user device, the user feedback, which may be in a textual format and/or an audio format. For example, the user interface may include a designated entry field in which the user may input the user feedback (e.g., via a keyboard and/or a microphone of or connected to the user device). Additionally, or alternatively, the user interface may present selectable feedback options (e.g., “like,” or “dislike”) and/or a rating scale (e.g., 1-5) for the user to provide the user feedback.

The user feedback may be for each selected feature and/or may be overall for the combination of selected features. For example, for a selected feature of a headlight of a vehicle, the user feedback may indicate that the user likes the look of the headlight. For a combination of selected features (e.g., a headlight and bumper of a vehicle), the user feedback may indicate that the user likes the way the combined features look together.

As shown by reference number 115, the user device may transmit, and the processing system may receive, user preference selection data. The user preference selection data may indicate the selection of the selected section(s) of the image corresponding to the selected features of the object. The user preference selection data also may indicate the user feedback. The user device may transmit the user preference selection data based on a user interaction with the user interface, such as pressing a submission button.

As shown in FIG. 1B, and by reference number 120, the processing system may identify the features of the object (also referred to as object features or vehicle features for the specific example in which the object is a vehicle) corresponding to the selected section(s) from the image. For example, in implementations in which the user circled the section of the image, the processing system may be configured to determine the corresponding feature of the object circled. As an example, if the object is a vehicle, and the user circled sections of the image corresponding to the headlights and the taillights, the processing system may be able to identify, from the user preference selection data, that the selected features are the headlights and the taillights. In some implementations, the processing system may use a machine learning model (also referred to herein as a first machine learning model) to identify the object features. The first machine learning model may utilize an image recognition technique. The first machine learning model may be trained based on multiple reference images associated with multiple reference objects (e.g., reference vehicles). The reference objects may be of varying types, brands, models, shapes, sizes, colors, etc.

As shown in FIG. 1C, and by reference number 125, the processing system may determine a user preference score for the selected feature(s). The user preference score may correspond to a user preference level associated with the object feature(s) and may be based on the user feedback indicated in the user preference selection data. The user preference score may be a numerical value (e.g., on a scale from −100 to 100). For example, if the user feedback indicates a positive preference level (e.g., the user really likes the selected feature(s)), then the user preference score may be a positive number. If the user feedback indicates a negative preference level (e.g., the user really dislikes the selected feature(s)), then the user preference score may have a negative value. If the user feedback indicates a moderate user preference level (e.g., the user was indifferent regarding the selected feature(s)), then the user preference score may range from a negative value to a positive value within some threshold (e.g., 5, 10, or 20) of 0.

In some implementations, the processing system may determine multiple user preference scores corresponding to different selected features or combinations or subsets of the selected features. The processing system may determine user preference scores based on one or more different feature types or categories associated with the selected features or combinations/subsets. For example, a vehicle may have feature categories that include exterior of vehicle, interior of vehicle, front of vehicle, rear of vehicle, passenger side of vehicle, driver side of vehicle, safety features, etc.

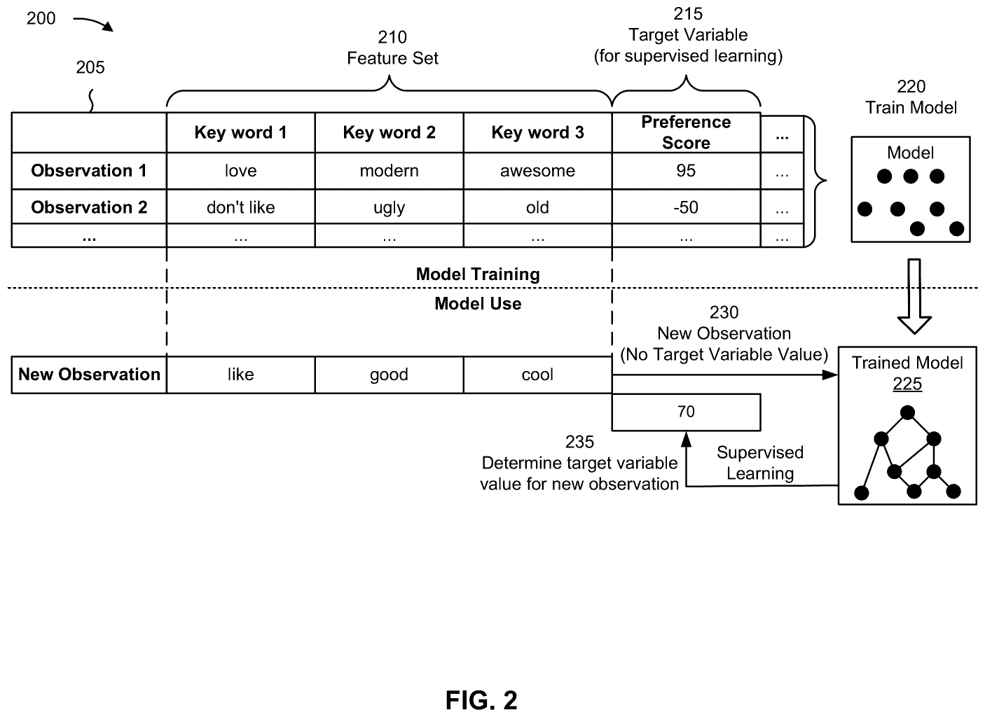

In some implementations, such as when the user feedback is in the form of text and/or audio, the processing system may use a machine learning model (also referred to herein as a second machine learning model) to process and analyze the user feedback. In such implementations, the machine learning model may use a natural language processing technique. As described in more detail with respect to FIG. 2 below, the processing system may provide the user feedback, indicated in the user preference selection data, as input to the second machine learning model, and may receive the user preference score as output from the second machine learning model. Additionally, or alternatively, in implementations in which the user feedback is provided based on selectable feedback options, each option may correspond to a particular score or range of scores.

As shown by reference number 130, the processing system may store user preference data indicating the user preference score. For example, the processing system may store the user preference data in a user profile database (e.g., under a user account associated with the user). Additionally, or alternatively, the processing system may temporarily store the user preference data as cache. Accordingly, the processing system may access, at a later time, the user preference score to determine and provide optimal search results corresponding to the user preferences, as described below with respect to FIG. 1D.

As shown in FIG. 1D, a user may perform a search for the object associated with the user preference score (e.g., vehicles). For example, the user may enter a search request via the user device (e.g., in a dedicated input field displayed in a user interface). As shown by reference number 135, the user device may transmit, and the processing system may receive, the search request (also referred to as a vehicle search request). Based on the search request and the user preference score, the processing system may perform a search. For example, after receiving the search request, the processing system may retrieve or otherwise obtain the user preference score corresponding to the subject matter of the search request (e.g., the object). The processing system may then search for results (e.g., from a vehicle database) that correspond to the user preference score and/or the user preference level. For example, if the user preference score indicates a high or a positive user preference level, then the search results may include objects (e.g., vehicles) that include at least a subset of the selected feature(s). If the user preference score indicates a negative user preference level, then the search results may include objects (e.g., vehicles) that exclude (e.g., do not include) at least a subset of the selected feature(s).

In some implementations, the processing system may perform the search, using an image repository, based on the selected feature(s) to identify a set of objects that have a same object category as the object (e.g., a vehicle) and that have at least one feature that shares a threshold degree of similarity with at least one of the selected feature(s). In some implementations, the image processing system may determine the threshold degree of similarity based on performing one or more image analysis and/or image comparison techniques. Additionally, or alternatively, the image processing technique may use a trained machine learning model to identify the set of objects that have the same object category and/or that have one or more features that share a threshold degree of similarity (e.g., with respect to a visual characteristic) as the selected feature(s).

In some situations, some of the search results may not include all of the selected features (e.g., associated with a positive user preference level) or exclude all of the selected features (e.g., associated with a negative user preference level). In such situations, the processing system may determine a preference ranking of the selected features. The preference ranking may be provided by the user, such as when the user makes the selections and provides the user feedback. Additionally, or alternatively, the processing system may use a preset preference ranking, which may be based on one or more factors (e.g., frequency of the feature in different types of the objects, or user preference scores of other users for the same or similar features).

In some implementations, the processing system may determine a user cluster associated with the user based on one or more factors, and the search results further may be based on user preferences associated with one or more other users in the user cluster. The factor(s) may include the user preference score associated with the user (e.g., other users having similar user preference scores for the same selected feature(s) or combination of selected feature(s)), object features associated with the user (e.g., other users having similarly selected feature(s) or combination of feature(s)), a geographic location (e.g., a zip code, a state, a region, or a country) associated with the user, and/or demographic information (e.g., age, sex, age range, socioeconomic status) associated with the user.

As shown by reference number 140, the processing system may transmit the search results to the user device, which may display the results in a user interface on the user device. The search results may be presented in a list and/or in an order of closest match to the selected features (e.g., the search result having the most common features with the selected features may be presented first) and/or based on the preference ranking.

In implementations in which a machine learning model (e.g., the second machine learning model) is used to determine the user preference score, the processing system may re-train the machine learning model based on user feedback on the search results. The user feedback may be explicit. For example, the user may provide comments about the search results (e.g., the search results accurately reflected the user's preferences). Additionally, or alternatively, the user feedback may be implicit. For example, the user feedback may be implied based on traffic by the user device associated with the user results.

As described herein, the processing system may be able to determine a user preference level (e.g., via a user preference score) for a feature or combination of features of an object selected by a user. Based on user feedback received from the user device of the user, the system may be able to determine the user preference level associated with the feature(s). The system may then perform a search associated with the object and based on the user preferences, and provide the search results to the user device. In this way, the system may provide the user with more relevant search results (e.g., based on the user's preferences) as compared to a search engine that performs a textual search without accounting for inferences about the relative importance of the object features based on the user feedback. As a result, computing, network, and/or memory resources, which would otherwise have been used to search for, obtain, transmit, and display sub-optimal search results that would not be of interest to the user, may be conserved.

As indicated above, FIGS. 1A-1D are provided as an example. Other examples may differ from what is described with regard to FIGS. 1A-1D.

FIG. 2 is a diagram illustrating an example 200 of training and using a machine learning model in connection with image-based determination of user preferences. The machine learning model training and usage described herein may be performed using a machine learning system. The machine learning system may include or may be included in a computing device, a server, a cloud computing environment, or the like, such as the processing system described in more detail elsewhere herein.

As shown by reference number 205, a machine learning model may be trained using a set of observations. The set of observations may be obtained from training data (e.g., historical data), such as data gathered during one or more processes described herein. In some implementations, the machine learning system may receive the set of observations (e.g., as input) from the processing system, as described elsewhere herein.

As shown by reference number 210, the set of observations may include a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the processing system. For example, the machine learning system may identify a feature set (e.g., one or more features and/or feature values) by extracting the feature set from structured data, by performing natural language processing to extract the feature set from unstructured data, and/or by receiving input from an operator.

As an example, a feature set for a set of observations may include a first feature of a first key word (key word 1), a second feature of a second key word (key word 2), a third feature of a third key word (key word 3), and so on. As shown, for a first observation, the first feature may have a value of “love,” the second feature may have a value of “modern,” the third feature may have a value of “awesome,” and so on. These features and feature values are provided as examples, and may differ in other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes, classifications, or labels) and/or may represent a variable having a Boolean value. A target variable may be associated with a target variable value, and a target variable value may be specific to an observation. In example 200, the target variable is preference score, which has a value of 95 for the first observation.

The feature set and target variable described above are provided as examples, and other examples may differ from what is described above. For example, a target variable may be the user preference level instead of or in addition to the user preference score.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, or the like. After training, the machine learning system may store the machine learning model as a trained machine learning model 225 to be used to analyze new observations.

As shown by reference number 230, the machine learning system may apply the trained machine learning model 225 to a new observation, such as by receiving a new observation and inputting the new observation to the trained machine learning model 225. As shown, the new observation may include a first feature of a first key word having a value of “like,” a second feature of a second key word having a value of “good,” a third feature of a third key word having a value of “cool,” and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 225 may predict a value of 70 for the target variable of the user preference score for the new observation, as shown by reference number 235. Based on this prediction, may perform a first automated action and/or may cause a first automated action to be performed (e.g., by instructing another device to perform the automated action), among other examples. The first automated action may include, for example, performing a search based on the object and the user preference score, as described above with respect to implementation 100.

In some implementations, the trained machine learning model 225 may be re-trained using feedback information. For example, feedback may be provided to the machine learning model. The feedback may be associated with automated actions performed, or caused, by the trained machine learning model 225. In other words, the actions output by the trained machine learning model 225 may be used as inputs to re-train the machine learning model (e.g., a feedback loop may be used to train and/or update the machine learning model). For example, the feedback information may include traffic, by the user device, associated with the search results.

In this way, the machine learning system may apply a rigorous and automated process to determine image-based user preferences to perform an optimal search. The machine learning system may enable recognition and/or identification of tens, hundreds, thousands, or millions of features and/or feature values for tens, hundreds, thousands, or millions of observations, thereby increasing accuracy and consistency and reducing delay associated with determining image-based user preferences to perform an optimal search relative to requiring computing resources to be allocated for tens, hundreds, or thousands of operators to manually determine image-based user preferences to perform an optimal search using the features or feature values.

As indicated above, FIG. 2 is provided as an example. Other examples may differ from what is described in connection with FIG. 2.

FIG. 3 is a diagram of an example environment 300 in which systems and/or methods described herein may be implemented. As shown in FIG. 3, environment 300 may include a processing system 310, a user device 320, an image database 330, a user profile database 340, a vehicle database 350, and a network 360. Devices of environment 300 may interconnect via wired connections, wireless connections, or a combination of wired and wireless connections.

The processing system 310 may include one or more devices capable of receiving, generating, storing, processing, providing, and/or routing information associated with image-based determination of user preferences, as described elsewhere herein. The processing system 310 may include a communication device and/or a computing device. For example, the processing system 310 may include a server, such as an application server, a client server, a web server, a database server, a host server, a proxy server, a virtual server (e.g., executing on computing hardware), or a server in a cloud computing system. In some implementations, the processing system 310 may include computing hardware used in a cloud computing environment.

The user device 320 may include one or more devices capable of receiving, generating, storing, processing, and/or providing information associated with image-based determination of user preferences, as described elsewhere herein. The user device 320 may include a communication device and/or a computing device. For example, the user device 320 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The image database 330 may include one or more devices capable of receiving, generating, storing, processing, and/or providing information associated with image-based determination of user preferences, as described elsewhere herein. The image database 330 may include a communication device and/or a computing device. For example, the image database 330 may include a data structure, a database, a data source, a server, a database server, an application server, a client server, a web server, a host server, a proxy server, a virtual server (e.g., executing on computing hardware), a server in a cloud computing system, a device that includes computing hardware used in a cloud computing environment, or a similar type of device. As an example, the image database 330 may store images of various kinds of vehicles (e.g., vehicle types, manufacturers, and/or models) and/or vehicle features, as described elsewhere herein.

The user profile database 340 may include one or more devices capable of receiving, generating, storing, processing, and/or providing information associated with image-based determination of user preferences, as described elsewhere herein. The user profile database 340 may include a communication device and/or a computing device. For example, the user profile database 340 may include a data structure, a database, a data source, a server, a database server, an application server, a client server, a web server, a host server, a proxy server, a virtual server (e.g., executing on computing hardware), a server in a cloud computing system, a device that includes computing hardware used in a cloud computing environment, or a similar type of device. As an example, the user profile database 340 may store user information associated with a user (e.g., name, geographic location, and/or demographic information), user preferences, and/or user preference scores, as described elsewhere herein.

The vehicle database 350 may include one or more devices capable of receiving, generating, storing, processing, and/or providing information associated with image-based determination of user preferences, as described elsewhere herein. The vehicle database 350 may include a communication device and/or a computing device. For example, the vehicle database 350 may include a data structure, a database, a data source, a server, a database server, an application server, a client server, a web server, a host server, a proxy server, a virtual server (e.g., executing on computing hardware), a server in a cloud computing system, a device that includes computing hardware used in a cloud computing environment, or a similar type of device. As an example, the vehicle database 350 may store vehicle information (e.g., manufacturer, model, trim, and/or vehicle features) associated with various vehicles, as described elsewhere herein.

The network 360 may include one or more wired and/or wireless networks. For example, the network 360 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 360 enables communication among the devices of environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

FIG. 4 is a diagram of example components of a device 400 associated with image-based determination of user preferences. The device 400 may correspond to processing system 310, user device 320, image database 330, user profile database 340, and/or vehicle database 350. In some implementations, processing system 310, user device 320, image database 330, user profile database 340, and/or vehicle database 350 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

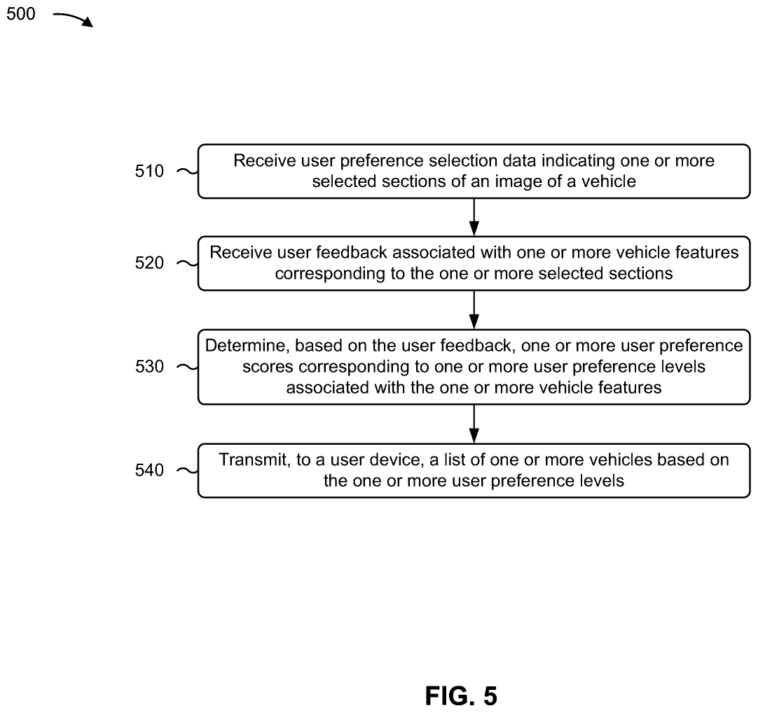

FIG. 5 is a flowchart of an example process 500 associated with image-based determination of user preferences. In some implementations, one or more process blocks of FIG. 5 may be performed by the processing system 310. In some implementations, one or more process blocks of FIG. 5 may be performed by one or more components of the device 400, such as processor 420, memory 430, input component 440, output component 450, and/or communication component 460.

As shown in FIG. 5, process 500 may include receiving user preference selection data indicating one or more selected sections of an image of a vehicle (block 510). For example, the processing system 310 (e.g., using processor 420, memory 430, input component 440, and/or communication component 460) may receive user preference selection data indicating one or more selected sections of an image of a vehicle, wherein the one or more selected sections correspond to one or more vehicle features of the vehicle, as described above in connection with reference number 115 of FIG. 1A.

As further shown in FIG. 5, process 500 may include receiving user feedback associated with the one or more vehicle features (block 520). For example, the processing system 310 (e.g., using processor 420, memory 430, input component 440, and/or communication component 460) may receive user feedback associated with the one or more vehicle features, as described above in connection with reference number 115 of FIG. 1A.

As further shown in FIG. 5, process 500 may include determining, based on the user feedback, one or more user preference scores corresponding to one or more user preference levels associated with the one or more vehicle features (block 530). For example, the processing system 310 (e.g., using processor 420 and/or memory 430) may determine, based on the user feedback, a user preference score corresponding to a user preference level associated with the one or more vehicle features, as described above in connection with reference number 125 of FIG. 1C.

As further shown in FIG. 5, process 500 may include transmitting, to a user device, a list of one or more vehicles based on the one or more user preference levels (block 540). For example, the processing system 310 (e.g., using processor 420, memory 430, and/or communication component 460) may transmit, to a user device, a list of one or more vehicles based on the user preference level, as described above in connection with reference number 140 of FIG. 1D.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1D. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for image-based determination of user preferences, the system comprising:
a memory; and
one or more processors, communicatively coupled to the memory, configured to:
transmit, to a user device of a user, image data indicating one or more images associated with a vehicle;
receive, from the user device and for a particular image of the one or more images, user preference selection data indicating a selection by the user of one or more selected sections of the particular image corresponding to one or more vehicle features of the vehicle,
wherein the user preference selection data indicates user feedback associated with the one or more vehicle features;
identify, using a first machine learning model, the one or more vehicle features corresponding to the one or more selected sections,
wherein the first machine learning model is trained via a plurality of reference images associated with a plurality of reference vehicles;
provide the user feedback as input to a second machine learning model,
wherein the second machine learning model uses a natural language processing technique to process the user feedback;
receive, as output from the second machine learning model, a user preference score corresponding to a user preference level associated with the one or more vehicle features; and
store, under a user account associated with the user, user preference data indicating the user preference score and the one or more vehicle features.

2. The system of claim 1, wherein the one or more processors are further configured to:
receive, from the user device, a vehicle search request;
perform a vehicle search based on the vehicle search request; and
transmit, to the user device and based on the user preference data, search results including vehicle data corresponding to one or more vehicles.

3. The system of claim 2, wherein the one or more processors are further configured to:
determine one or more visual characteristics corresponding to the one or more vehicle features; and
wherein the one or more processors, when performing the vehicle search, are configured to:
perform the vehicle search based on the one or more visual characteristics to identify the one or more vehicles,
wherein a particular vehicle, of the one or more vehicles, includes one or more vehicle features having visual characteristics that have a threshold degree of similarity with the one or more visual characteristics.

4. The system of claim 2, wherein the user preference score indicates a positive user preference level associated with the one or more vehicle features, and
wherein the one or more vehicles are associated with at least a subset of the one or more vehicle features.

5. The system of claim 2, wherein the user preference score indicates a negative user preference level associated with the one or more vehicle features, and
wherein the one or more vehicles exclude at least a subset of the one or more vehicle features.

6. The system of claim 2, wherein the one or more processors are further configured to:
re-train the second machine learning model based on user feedback on the search results.

7. The system of claim 2, wherein the one or more vehicle features includes a plurality of vehicle features, and
wherein the one or more processors are further configured to:
determine a preference ranking of the plurality of vehicle features; and
provide the search results in an order based on the ranking of the plurality of vehicle features.

8. The system of claim 2, wherein the one or more processors are further configured to:
determine, based on one or more factors, a user cluster associated with the user,
wherein the search results are further based on user preferences associated with one or more other users in the user cluster.

9. The system of claim 8, wherein the one or more factors include at least one of:
the user preference score associated with the user,
the vehicle features associated with the user,
a geographic location associated with the user, or
demographic information associated with the user.

10. A method of image-based determination of user preferences, the method comprising:
receiving, by a system having one or more processors, user preference selection data indicating one or more selected sections of an image of a vehicle,
wherein the one or more selected sections correspond to one or more vehicle features of the vehicle;
receiving, by the system, user feedback associated with the one or more vehicle features;
determining, by the system and based on the user feedback, one or more user preference scores corresponding to one or more user preference levels associated with the one or more vehicle features; and
transmitting, by the system and to a user device, a list of one or more vehicles based on the one or more user preference levels.

11. The method of claim 10, further comprising:
receiving, from the user device, a vehicle search request,
wherein transmitting the list of the one or more vehicles is based on the vehicle search request.

12. The method of claim 10, further comprising:
determining one or more visual characteristics corresponding to the one or more vehicle features,
wherein a particular vehicle, of the one or more vehicles, includes one or more vehicle features having visual characteristics that have a threshold degree of similarity with the one or more visual characteristics.

13. The method of claim 10, wherein a particular user preference score, of the one or more user preference scores, indicates a positive user preference level associated with at least a subset of the one or more vehicle features, and wherein the
wherein the one or more vehicles are associated with one or more vehicle features of the at least a subset of the one or more vehicle features.

14. The method of claim 10, wherein a particular user preference score, of the one or more user preference scores, indicates a negative user preference level associated with at least a subset of the one or more vehicle features, and
wherein the one or more vehicles exclude one or more vehicle features of the at least a subset of the one or more vehicle features.

15. The method of claim 10, wherein determining the one or more user preference scores comprises:
determining a particular user preference score, of the one or more user preference scores, for a corresponding feature category.

16. A non-transitory computer-readable medium storing a set of instructions, the set of instructions comprising:
one or more instructions that, when executed by one or more processors of a device, cause the device to:
transmit, to a user device, image data indicating one or more images associated with a vehicle;
receive, from the user device and for a particular image of the one or more images, user preference selection data indicating a selection of selected sections of the particular image corresponding to a set of vehicle features of the vehicle,
wherein the user preference selection data indicates user feedback associated with the set of vehicle features;
determine, based on the user feedback, a user preference score corresponding to a user preference level associated with the set of vehicle features; and
store, under a user account associated with the user, user preference data indicating the user preference score and the one or more vehicle features.

17. The non-transitory computer-readable medium of claim 16, wherein the one or more instructions, when executed by the one or more processors, further cause the device to:
receive, from the user device, a vehicle search request;
perform a vehicle search based on the vehicle search request; and
transmit, to the user device and based on the user preference data, search results including vehicle data corresponding to one or more vehicles.

18. The non-transitory computer-readable medium of claim 17, wherein the one or more instructions, when executed by the one or more processors, further cause the device to:
determine one or more visual characteristics corresponding to the set of vehicle features; and
wherein the one or more processors, when performing the vehicle search, are configured to:
perform the vehicle search based on the one or more visual characteristics to identify the one or more vehicles,
wherein a particular vehicle, of the one or more vehicles, includes one or more vehicle features having visual characteristics that have a threshold degree of similarity with the one or more visual characteristics.

19. The non-transitory computer-readable medium of claim 17, wherein the user preference score indicates a positive user preference level associated with the set of vehicle features, and
wherein the one or more vehicles are associated with at least a subset of the set of vehicle features.

20. The non-transitory computer-readable medium of claim 17, wherein the user preference score indicates a negative user preference level associated with the set of vehicle features, and
wherein the one or more vehicles exclude at least a subset of the set of vehicle features.
